(19) United States
(12) Patent Application Publication
(10) Pub. No.: US 2002/0050254 A1
(43) Pub. Date: May 2, 2002

(54) Two cycle internal combustion engine

(76) Inventor: William Delaplaine Green, Alexandria, VA (US)

Correspondence Address: William Delaplaine Green, 8906 Camden Street, Alexandria, VA, 22308-2715, US

(21) Appl. No.: 09/918,559

(22) Filed: Aug. 1, 2001

Related U.S. Application Data
(60) Provisional application No. 60/221,914, filed on Jul. 31, 2000.

(51) Int. Cl. F02B 33/00

(52) U.S. Cl. 123/68

(57) ABSTRACT

A positive displacement gear type air compressor enclosed within the engine housing forces air in between the compressor and the reciprocating means. At approximately top dead center fuel is injected into the engine and burns. The high pressures of combustion transfer energy to the gears of the compressor and the reciprocating meansand crankshaft assembly forcing them to accelerate. The reciprocating means accelerates to the bottom dead center position completely uncovering two exhaust ports. Exhaust passes through the exhaust ports and is scavenged with compressed air from the compressor flowing into the housing space enclosing the reciprocating means. The reciprocating means returns to the top dead center position compressing air in the housing space between the compressor and the reciprocating means. At approximately top dead center the process repeats itself.

This is a continuation in part of parent applications No. 60/221,914 files 07/31/200; 60/222,321 filed Aug. 1, 2000; patent application No. 60/222,661 files Aug. 3, 2000; patent number 60/222,924 filed Aug. 4, 2000; patent application 60/223,310 filed Aug. 7, 2000; patent application 60/223,733 filed Aug. 8, 2000; and another provisional application file Aug. 1, 2001.

### ABSTRACT

A crankshaft driven positive displacement gear type air compressor enclosed within the engine housing forces air in between the compressor and reciprocating means. At approximately top dead center fuel is injected into the engine and burns. The high pressures of combustion transfer energy to the gears of the compressor and the reciprocating means and crankshaft assembly forcing them to accelerate. The reciprocating means accelerates to the bottom dead center position completely uncovering two exhaust ports. Exhaust passes through the exhaust ports and is scavenged with compressed air from the compressor flowing into the housing space enclosing the reciprocating means. The reciprocating means returns to the top dead center position compressing air in the housing space between the compressor and the reciprocating means. At approximately top dead center the process repeats itself.

### DISCLOSURE INFORMATION STATEMENT

In preparation for filing of this application, a pre-examination patent ability search was performed. Among the classes and subclasses reviewed were Class 123, subclasses 27R, 65B, 65BA, 68, 198C, 213, 257, 268, 316, 528, 533, 559.1, 561, 565, and 564. Computer searching was also done on the PTO patent database. The search uncovered the following:

| U.S. Pat. No. | Inventor | Date of Issue |
|---|---|---|
| 6,135,070 | R. A. Crandall | Oct. 24, 2000 |
| 5,878,703 | K. Sweeney | Mar. 9, 1999 |
| 5,746,163 | E. Green | May 5, 1998 |
| 5,388,561 | H. Cullum, J. Korn | Feb. 14, 1995 |
| 5,375,581 | G. Alander, H. Hofmann | Dec. 27, 1994 |
| 5,179,921 | V. Figliuzzi | Jan. 19, 1993 |
| 4,984,540 | K. Morikawa | Jan. 15, 1991 |
| 4,860,699 | J. Rocklein | Aug. 29, 1989 |
| 4,671,218 | C. Weiland | Jun. 9, 1987 |
| 4,539,948 | R. R. Toepel | Sep. 10, 1985 |
| 4,398,509 | E. Offenstadt | Aug. 16, 1983 |
| 2,851,021 | G. W. Covone | Sep. 9, 1958 |
| 2,708,919 | R. D. Wellington | May 24, 1955 |
| 2,686,503 | V. C. Reddy | Aug. 17, 1954 |
| 2,356,379 | D. F. Cans | Aug. 22, 1944 |
| 2,312,661 | D. Messner | March 2, 1943 |
| 2,067,984 | J. Ross | Jan. 19, 1937 |
| 2,062,621 | F. A. Truesdell | Dec. 1, 1936 |
| 1,720,414 | F. Gruebler | July 9, 1929 |
| 1,273,667 | J. A. Poyet | July 23, 1918 |
| 1,220,893 | E. A. Rundlof | Mar. 27, 1917 |

Designs for two stroke internal combustion engines are disclosed in the art that use positive displacement pumps to charge the cylinder with air prior to ignition. Compressed air is also used to scavenge the cylinder of combustion products during the exhaust cycle of the engine. Various methods of charging the cylinder with the compressed air produced by a positive displacement pump are disclosed in the art. Often a camshaft actuated poppet valve closing off the cylinder from the air passage leading from the air compressor is timed by the camshaft to open and allow the compressed air to enter the cylinder during part of the exhaust cycle to fill the cylinder and push out remaining exhaust gases before the exhaust port has opened.

One such design is disclosed in the U.S. Pat. No. 4,671,218 issued to Weiland. In this patent there is disclosed a gear type positive displacement pump used to charge a holding chamber located above the cylinder with compressed air through which a valve stem projects to the valve face that seals the intake port located in the floor of the holding chamber from the cylinder beneath it. A crankshaft driven camshaft actuates the intake valve while the exhaust ports are open, which are located in the cylinder wall just above the face of the piston when it is at bottom dead center, allowing compressed air from the compressor to fill the cylinder and scavenge the cylinder of remaining exhaust gases. While this design appears to be simple and straightforward it has the disadvantage of using a camshaft to operate the intake valve and such a design adds to the cost and complexity of the machine and diminishes its performance by using engine output to operate the camshaft and valve. It also has the disadvantage of fresh air being able to enter the open exhaust ports before they close since the camshaft is timed to open the intake valve and allow compressed air from the compressor into the cylinder while the exhaust ports are still open. This will reduce the temperature of the exhaust gases reducing the effectiveness of catalytic converters designed to reduce exhaust emissions, which require high exhaust temperatures for maximum effectiveness. No means are shown to transfer the energy of combustion directly to the compressor gears during the power stroke of the engine.

The blower types described and illustrated in the patents found during a patent search are usually of the Roots type as disclosed in the Toepel Patent No. 4,539,948, the Green Pat. No. 5,746,163 and several others, turbocharger designs as disclosed in the Toepel Patent and Sweeney Patent No. 5,878,703 and others, or of the radial type as disclosed in the Rocklein Pat. No. 4,860,699, the Covone Pat. No. 2,851,021, and others. Only in the Weiland Patent and Figliuzzi Pat. No. 5,179,921 do we see a positive displacement gear pump used as a means to force air into the engine. In neither of these designs or in any of the other patents is shown an engine in which the compressor is located in the head of the engine and directly compresses air between the compressor and the reciprocating means without the use of intervening valve means to separate the compressor from the combustion process. Nowhere is such a valve means shown that does not use crankshaft power to operate it.

It is therefore an important object of one embodiment the present invention to eliminate intake valves from a compressor charged two cycle engine by placing a positive displacement gear type air compressor in the engine head which compresses combustible material directly between the compressor and the reciprocating means thereby receiving a transfer of power to the compressor gears during the power stroke of the engine.

### SUMMARY OF THE INVENTION

The invention comprises a two-stroke internal combustion engine. The simplest embodiment having a housing made of two identical parts welded or bolted together for easy manufacture, strength or assembly and disassembly. The housing has an intake port located in the uppermost wall of the housing for passing air into a gear type air compressor. The engine includes the air compressor formed by two partial cylinders enclosing the two gear shafts of the air compressor within the upper part of the housing below the intake port. The gear shafts output shafts pass through holes in the outer housing walls for the takeoff of power, and one of them is connected by rotational means connected to the output shaft of the crankshaft for a transfer of power between them. A passage for holding compressed air connects the outlet side of the air compressor to the top end of an internal housing space confining the reciprocating part of the engine so the compressor gears and the reciprocating part are simultaneously exposed to the forces of combustion during the power cycle of the engine. A fuel injector nozzle is located in the intake port for injection of fuel into the passage. The reciprocating part rotates within the housing space confining it as it reciprocates therein and two opposing sides of it have an outer perimeter surface shape conforming to the flat vertical walls of the housing space. The reciprocating part has a lower end section rotatably connected to a crankshaft located in the lower part of the housing space for converting the forces of combustion into useful an engine driven water pump included to circulate water through the water jacket and a radiator if needed, a fan to circulate air through the radiator, and conventional sensors and engine management systems included to produce optimum engine performance.

### BRIEF DESCRIPTION OF THE DRAWINGS

FIG. 1 is a side section view through a two-cycle internal combustion engine in accordance with one embodiment of the invention.

FIG. 2 is a partial side section view taken through a plane indicated by section line 2-2 in FIG. 1.

FIG. 3 is a side elevation view of a two-cycle internal combustion engine in accordance with one embodiment of the invention.

FIG. 4 is a top plan view of the internal combustion engine shown in FIG. 1.

FIG. 5 is a side section view through a two-cycle internal combustion engine in accordance with one embodiment of the invention.

FIG. 6 is a side section view through a two-cycle internal combustion engine in accordance with one embodiment of the invention.

FIG. 7 is a side section view through a two-cycle internal combustion engine in accordance with one embodiment of the invention.

### DESCRIPTION OF THE PREFERRED EMBODIMENT

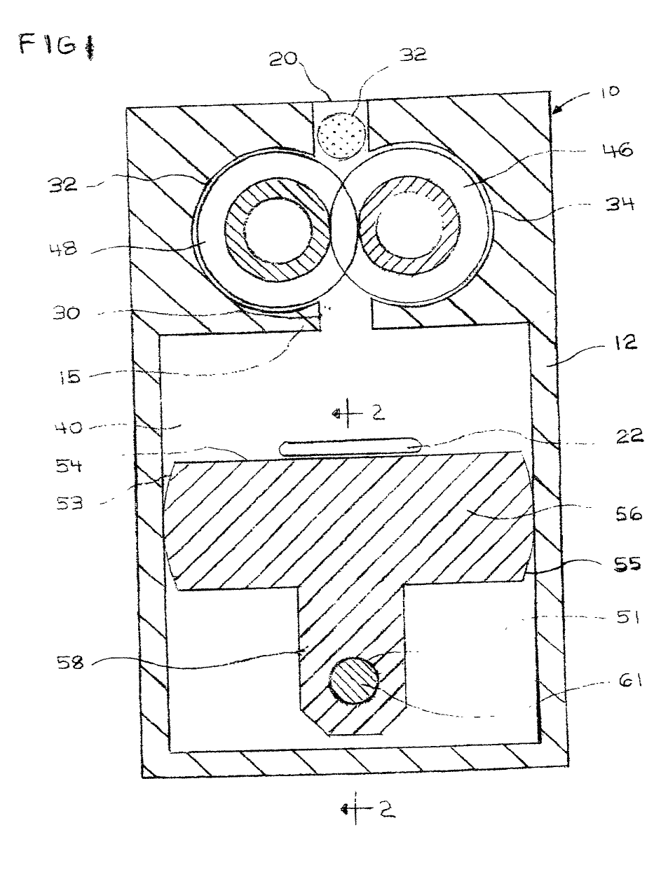

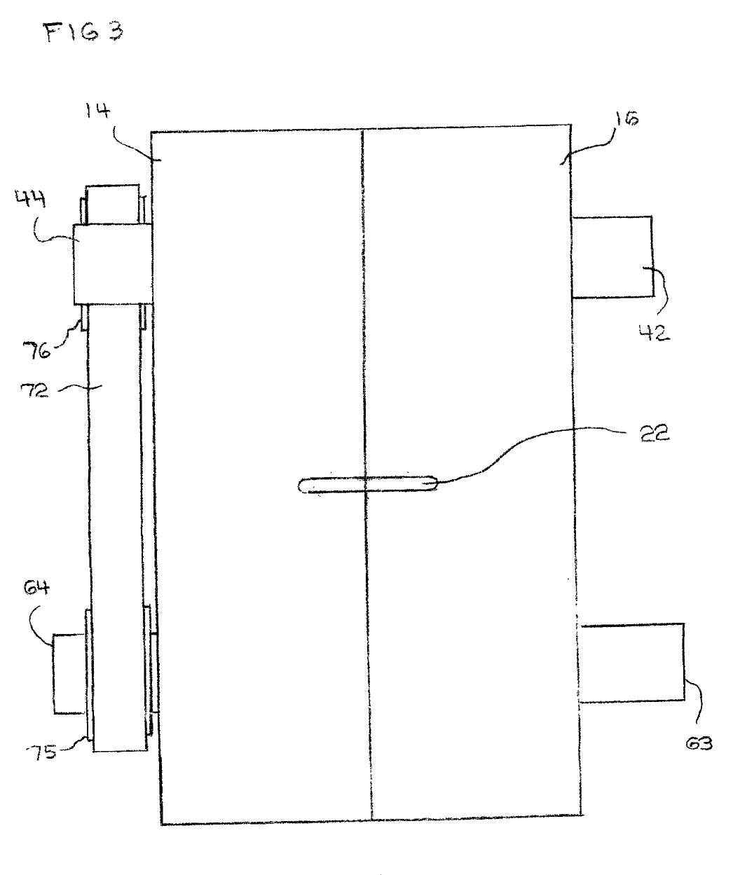

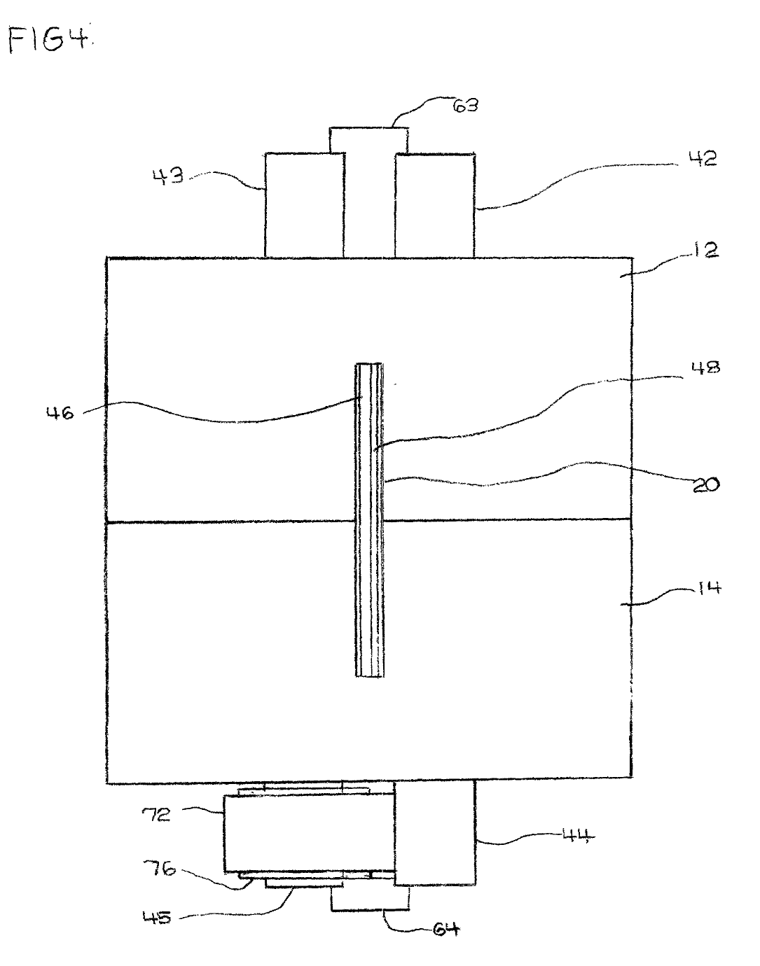

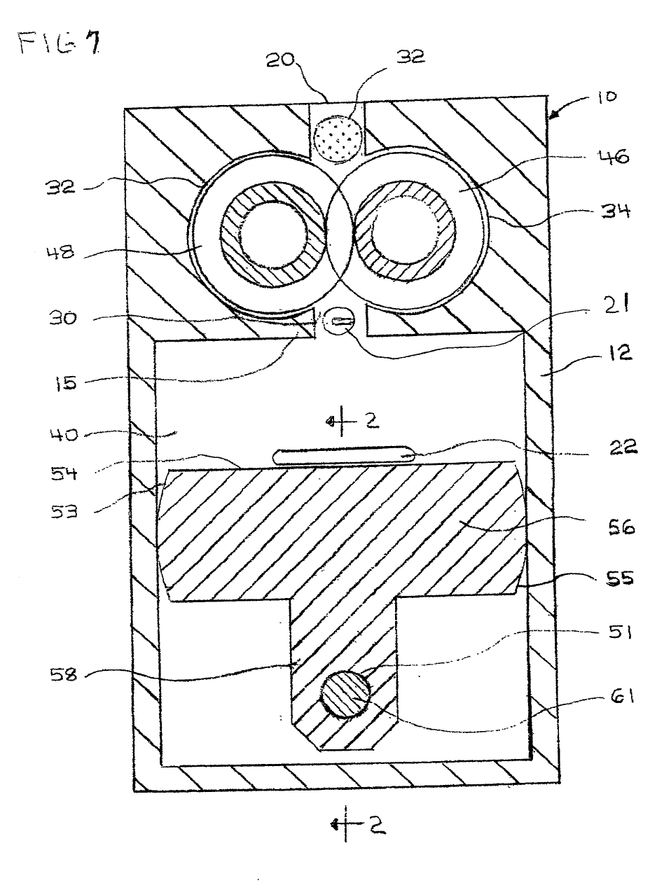

Referring now to the drawings in detail, FIG. 1-7 illustrate a two-cycle internal combustion engine constructed in accordance with one embodiment generally referred to by reference number 10. In this embodiment the engine is enclosed by a housing torque. The crankshaft output shafts pass through identical holes in the walls of the housing. The crankshaft, gear shafts and reciprocating part have internal passages (not shown) for the passage of lubricant to areas of the engine requiring lubrication. Lubricant is pumped into these passages through the ends of the shafts containing the passages before operating the engine. Two exhaust ports are located in two opposite housing walls above the bottom dead center position of the reciprocating part face and covered by the two flat opposing sides of the reciprocating part during the compression stroke and allow the escape of exhaust gases confined within the housing near the end of the power stroke. Fuel timing and pressure regulation means are provided to allow correct amounts of fuel to be injected into the engine at the proper intervals. Because the reciprocating part and the compressor gears are exposed simultaneously to the forces of combustion, which transfer energy to these parts, and the power generated by them is combined through power transfer means connecting an output shaft of the crankshaft to an output shaft of a gear shaft, this machine has an improved performance compared to other types of two cycle engines.

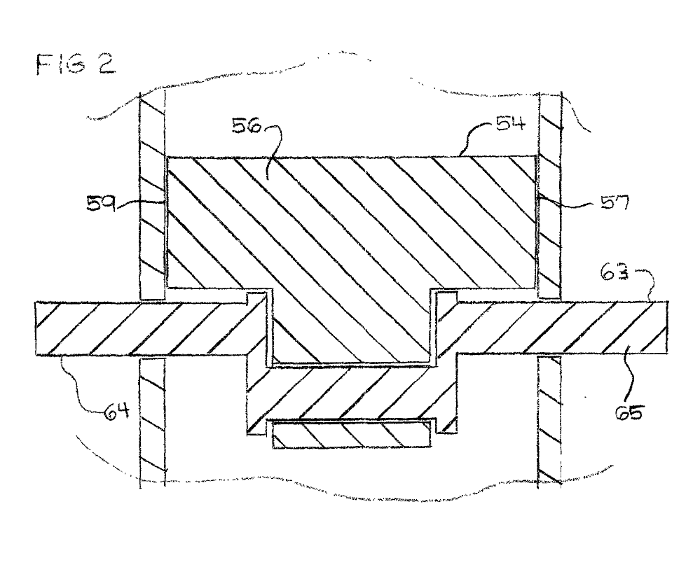

In any embodiments of this invention, a conventional cylinder, piston and rod combination can be included to replace the reciprocating part and housing enclosure shown, a conventional oil pump and oiling system can be included to provide oil to the cylinder walls, crankshaft bearings, rod bearings and gear shaft output rod bearings, conventional bearings means included for support of rotating parts, conventional fuel supply means for supply of fuel to the fuel injector, conventional spark ignition means can be included to ignite the fuel and air mixture, a water jacket can be included to provide cooling means to embodiments that do not include a water jacket and if necessary assembly 12, which is formed from two identical housing sections, 14 and 16 that have been welded together. As shown in FIG. 1 an intake port 20 is formed in the top wall of housing 10, and a fuel injector 32 projects into intake port 20 through the rear wall of housing section 14 for injecting fuel into port 20. The lower end of intake port 20 connects two parallel partial cylinders 32 and 34 that are horizontally aligned within housing 10 and contain hollow gear shafts 46 and 48 (teeth not shown) which are meshed together, having output shafts 42, 43, 44 and 45 extending through holes formed in the outer vertical walls of housing sections 14 and 16. The gear shafts 46 and 48 are crankshaft driven, counter rotating in opposite directions drawing intake air through intake port 20 and forcing the intake air into passage 30 from which it passes into housing space 40. Partial cylinders 32 and 34 are centrally connected at their lower side to outlet passage 30 traversing the length of partial cylinders 32 and 34 within housing 10 and extending through internal housing wall 15 to housing space 40 that contains reciprocating part 56. Formed within the housing walls enclosing housing space 40 are horizontal, generally elongated exhaust passages 22 and 24 passing through the walls of housing sections 14 and 16 and having flat upper and lower horizontal sides and curved vertical sides. The lower horizontal sides of exhaust passages 22 and 24 aligned horizontally with upper horizontal surface 54 of reciprocating part 56 when reciprocating part 56 is positioned at bottom dead center within housing space 40. Housing space 40 is a box shape enclosed by four flat internal vertical walls of housing 10. As can be more clearly seen in FIG. 1 and 2 reciprocating part 56 has an upper exterior horizontal surface 54, two vertically aligned exterior curved surfaces 53 and 55 tangent with opposing sides of housing space 40, two exterior vertical flat surfaces 57 and 59 that keep exhaust ports 22 and 24 covered during the compression stroke and are tangent with two opposing sides of housing space 40, and a lower depending section 58 with a transverse bearing hole 51 formed therein surrounding rod journal 61 of crankshaft 65. When crankshaft 65 rotates reciprocating part 56 rotates and the exterior curved vertical surfaces 53 and 55 rotate as they slide up and down the flat vertical walls of housing space 40 allowing constant contact with the opposing flat vertical walls of housing space 40. The crankshaft output shafts 63 and 64 pass through holes in housing sections 12 and 14 for external power transfer from the crankshaft. Crankshaft output shaft 64 is centrally attached to a drive pulley 75. The power transfer belt 72 circumscribes drive pulley 75 and extends around drive pulley 76, which is attached to the output shaft 45 of gear shaft 48.

During operation of the engine the crankshaft output shaft 64 rotates the drive pulley 75 transferring power to the drive belt 72 causing drive pulley 76, which is attached to gear shaft output shaft 45, to rotate and turn gear shaft 48. The teeth of gear shaft 48 rotate and force the teeth of gear shaft 46 to move forcing rotation of gear shaft 46. The rotation of the gear shafts 46 and 48, which are closely confined within partial cylinders 32 and 34 moves air received from intake port 20 along the circumference of partial cylinders 32 and 34 and into passage 30 from which it passes into housing space 40. As crankshaft 65 rotates reciprocating part 56 is pushed by crankshaft rod journal 61 towards internal horizontal housing wall 15, thereby reducing the volume within housing space 40 and compressing the air held therein between reciprocating part 56 and rotating gear shafts 48 and 46 of the air compressor. When reciprocating part 56 reaches approximately top dead center the fuel injector 32 injects fuel into the incoming air stream within intake port 20 and the fuel flows with the air into the air compressor. The air compressor discharges the fuel and air mixture received from intake port 20 into passage 30 containing the compressed air from the compressor. The high temperature of the compressed air confined within passage 30 ignites the incoming fuel mixture from the compressor. The forces of combustion transfer energy to the teeth of gear shafts 46 and 48 and to the reciprocating part 56 simultaneously causing these parts to accelerate. The acceleration of the gear shafts 46 and 48 transfers power to their output shafts 42, 43, 44 and 45 and the acceleration of the reciprocating part transfers energy to the crankshaft 65 thereby transferring power to the output shafts 63 and 64 which is combined with the power output of the gear shaft output shaft 45 through power transfer belt 72. As the gear shafts 46 and 48 accelerate they pump more air into the engine for combustion causing greater power to be generated. The fuel injector 20 is timed to turn off before reciprocating part 56 uncovers exhaust ports 22 and 24 so the combustion occurring within housing space 40 can finish before exhaust gases begin to pass out of the engine. Fresh air from the compressor enters housing space 40 and scavenges it of exhaust gases while the exhaust ports 22 and 24 are open and fills the housing space 40 with fresh air. As reciprocating part 56 moves towards top dead center, sides 57 and 59 of reciprocating part 56 covers the exhaust ports 22 and 24 and the air between the gear shafts 46 and 48 and reciprocating part 56 is compressed into passage 30 making the engine ready for another power stroke.

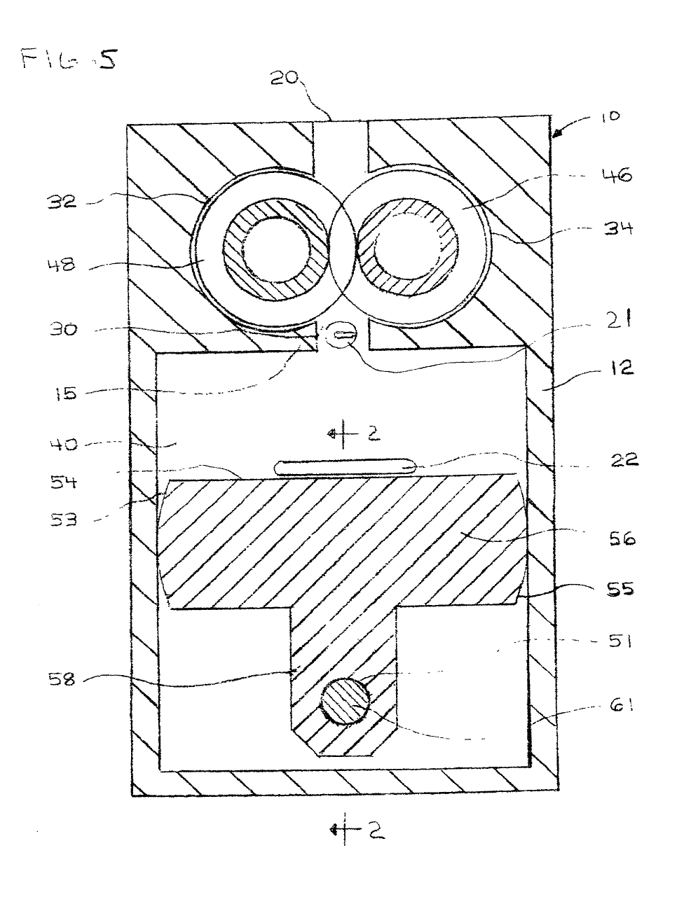

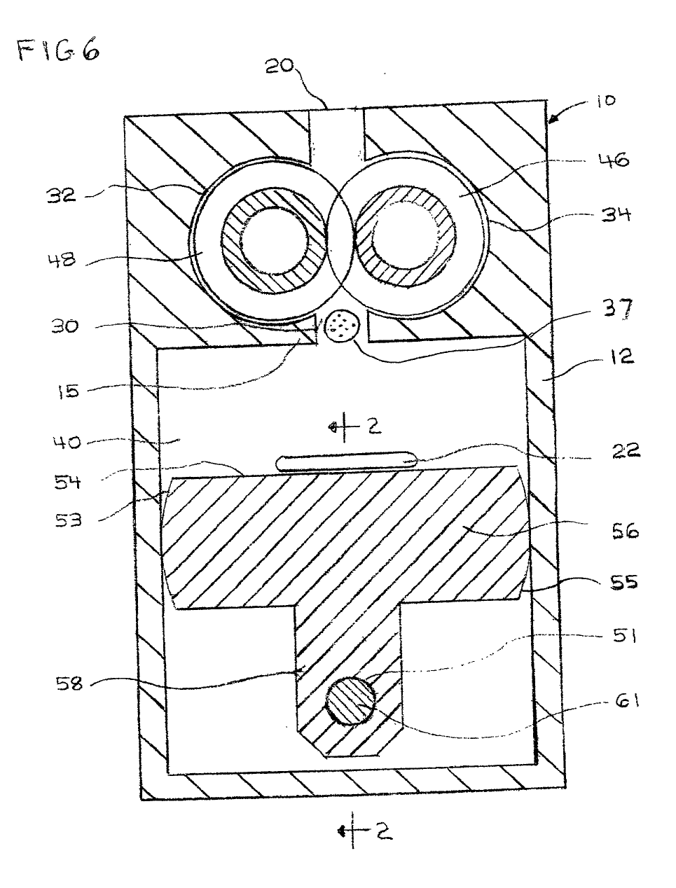

FIGS. 5, 6 and 7 illustrate different embodiments of the above described invention. FIG. 5 shows an embodiment in which ignition means 21 in housing passage 30 for ignition of the fuel mix compressed into the passage. Fuel is injected into the passage by fuel injector 37 positioned at the opposite end of passage 7. FIG. 6 shows the

What is claimed is:

1. In a two stroke internal combustion engine for the generation of useful rotational motion and torque having housing means for enclosing the necessary internal spaces within the engine, crankshaft means for the conversion of reciprocating motion into rotary motion and power output from the engine, reciprocating means for the transfer of energy created by combustion to the crankshaft and for compressing combustible material within the engine for combustion, fuel supply means for supplying fuel for combustion to the engine, air intake means for passing air at atmospheric pressure for combustion into space within the housing, exhaust gas outlet means for passing exhaust gases out of space within the housing, the improvement comprising a crankshaft driven positive displacement gear type air compressor located within the engine head to compress the air between the reciprocating means and the air compressor having power output shafts.

2. The improvement as defined within claim 1 wherein combustion initiates between the air compressor means and the reciprocating part so power is simultaneously transferred to the reciprocating part and the air compressor gears.

3. The improvement as defined in claim 2 wherein said housing means includes passage means between the compressor means and the reciprocating means for containing compressed air discharged by the air compressor and for receiving a fuel injector nozzle and or spark ignition device.

4. The improvement as defined in claim 3 wherein said passage means includes spark ignition means for initiating the combustion process.

5. The improvement as defined in claim 4 wherein said housing means is formed from two identical parts having identical holes in the outer walls for the passage of output shafts from the air compressor and the crankshaft, and identical openings for the exhaust gas outlet means, for ease of manufacture, assembly and disassemble and includes an internal box having vertical walls for containing the said reciprocating means.

6. The improvement as defined in claim 5 wherein said air compressor is comprised of two identical partial cylinders formed within the engine housing and two identical parallel meshed gear shafts enclosed by the said partial cylinders for compression of the air flowing into the air compressor through the air intake means.

7. The improvement as defined in claim 6 wherein said compressor output shafts are connected by power transfer means to the crankshaft output shaft

8. The improvement as defined in claim 7 wnerein said reciprocating means includes a generally rectangular shaped part having two curved vertical sides, two flat vertical sides and a central depending section having a transverse circular opening for rotational movement around the crankshaft rod journal.

9. The improvement as defined in claim 1 wherein said reciprocating means includes a generally rectangular shaped part having two curved vertical sides two flat vertical sides and a central depending section having a transverse circular opening for rotational movement around the crankshaft rod journal.

10. The improvement as defined in claim 9 wherein said housing means includes passage means between the compressor means and the reciprocating means for containing compressed air discharged by the air compressor and receiving a fuel injector nozzle and or spark ignition device.

11. The improvement as defined in claim 10 wherein said passage means includes a spark ignition device for initiating combustion within said passage means.

12. The improvement as defined in claim 11 wherein said fuel injection means injects fuel directly into said passage means for combustion of air and fuel within said passage means.

13. The improvement as defined in claim 12 wherein combustion initiates between the air compressor means and the reciprocating part so power is simultaneously transferred to the air compressor gears and the reciprocating part

14. The improvement as defined in claim 1 wherein said housing means is formed from two identical parts having identical holes in the outer walls for the passage of output shafts from the air compressor and the crankshaft, and identical openings for the exhaust gas outlet means, for ease of manufacture, assembly and disassembly and includes an internal box having vertical walls for containing the said reciprocating means.

15. The improvement as defined in claim 14 wherein combustion initiates between the air compressor means and the reciprocating part so power is simultaneously transferred to the air compressor gears and the reciprocating part during the combustion process.

16. The improvement as defined in claim 15 wherein said housing means includes passage means between the compressor means and the reciprocating means for containing compressed air discharged by the air compressor and receiving a fuel injector nozzle and or spark ignition device.

17. The improvement as defined in claim 16 wherein said fuel injection means injects fuel directly into said passage means for combustion of air and fuel within said passage means.

18. The improvement as defined in claim 1 wherein said housing means includes passage means between the compressor means and the reciprocating means for containing compressed air discharged by the air compressor.

19. The improvement as defined in claim 18 wherein passage means includes a spark ignition device for initiating combustion within said passage means

20. The improvement as defined in claim 19 wherein said air compressor is comprised of two identical partial cylinders formed within the engine housing and two identical parallel meshed gear shafts enclosed by the partial cylinders for compression of the air flowing into the compressor through the air intake means between the compressor and the said reciprocating means.
